(19) United States
(12) Patent Application Publication
(10) Pub. No.: US 2009/0266839 A1
(43) Pub. Date: Oct. 29, 2009

(54) Method and Device for Producing a Multicomponent Compound

(76) Inventors: Sven Meyer, Apensen (DE); Matthias Weihrauch, Klein Nordende (DE)

Correspondence Address: ALIX YALE & RISTAS LLP, 750 MAIN STREET, SUITE 1400, HARTFORD, CT, 06103, US

(21) Appl. No.: 11/988,827

(22) PCT Filed: Jun. 14, 2006
(86) PCT No.: PCT/EP2006/005737

§ 371 Date: Jan. 15, 2008

(30) Foreign Application Priority Data
Jul. 15, 2005 (DE) 10 2005 033 260.9

(51) Int. Cl. B01F 15/04; B01F 3/10; B01F 15/02

(52) U.S. Cl. 222/1; 222/57; 222/59; 222/135; 222/145.6

(57) ABSTRACT

The method and the device for producing a multicomponent compound, in particular for dental purposes, is characterized in that the drives of the pistons of cartridges are initially moved with a higher speed until air pockets in the cartridges are eliminated and said cartridges are filled only with the component, and in that the feed speed is then reduced to constant values with which the components can be pressed out.

### BACKGROUND

The disclosure relates to a method for producing a multicomponent compound, in particular for dental purposes, by pressing its components out of cartridges by means of pistons, each of which pistons is provided with a separate drive, and by mixing the components. The invention also relates to a device for carrying out the method.

Various problems occur in the production of multicomponent compounds, in particular for dental purposes. On the one hand, the components must be pressed in precisely the right mixture ratio into a mixer where they are mixed and can then be discharged. If the two components are to be used in equal quantities, then cylinders with equal diameter could be used as cartridges, with the pistons then also being moved forwards at the same speed in order to press out the components. This can take place by means of a single drive. With a device of said type, it would also be possible to press out components in some other ratio if the cartridges or cylinders have different diameters. A better adaptation to different mixing ratios is however obtained if each of the pistons is provided with a separate drive (DE 199 51 504 A1). In this way, it is possible to obtain the desired mixing ratio if the cartridges are actually filled and the pistons bear against the components such that no air pocket is present there. If an air pocket of said type is present in one of the cartridges, then material would of course initially be driven only out of one cartridge when both drives are set in operation, while in the other cartridge, the air would initially be compressed and escape such that no material or in any case far too little material is discharged. It would thus firstly be necessary to ensure by hand that no more air, but rather only the component, is situated in the cylinder space closed off by the piston. This is however time-consuming and complicated.

An object is that of creating a method and a device for producing a multicomponent compound with which said compound can be obtained quickly and in the correct mixture ratio.

### SUMMARY

During the pressing-out operation, the load state of the drives is determined, and
if the load state is detected for all the drives, the feed speeds are adjusted to predetermined constant values,
if the load state is detected for only some of the drives, said drives are stopped while the other drives are operated with a higher feed speed until the load state is also detected in each case in said other drives, and are then stopped, and in that the feed speeds for all the drives are subsequently adjusted to predetermined constant values,
if the load state is detected for none of the drives, the drives are operated with a higher feed speed until the load state is detected in each case in said drives, and are then stopped, and in that the feed speeds for all the drives are subsequently adjusted to predetermined constant values.

The simplest operating case is that the load state is detected for all of the drives, that is to say all the pistons already bear against the components without any air pockets. In this case, the feed speeds can be adjusted to predetermined constant values in order that the components are discharged uniformly in the correct ratio and passed into the mixer.

If the load state is detected for only some drives, that is to say other pistons can move easily, then air pockets are evidently still present at said other pistons. In this case, the drives of the pistons for which the load state is detected are stopped. The rest of the drives are then actuated until load state is likewise detected at said drives. It is subsequently possible to adjust the feed speed for all the drives to predetermined constant values. In this way, it is again ensured that the material is discharged uniformly and in the correct ratio. The drive of the pistons in fact takes place, for as long as no load state is detected (that is to say for as long as an air pocket is still present), with higher feed speeds. One thus more quickly reaches the state at which the process of pressing out the components begins. This saves time.

If the load state is detected for none of the drives, all the drives are operated with a higher feed speed until the load state is detected in each case. In this way, the state from which the pressing-out in the correct ratio can take place is again reached very quickly. If the load state is then detected for all of the drives, then the normal pressing-out with constant feed speeds can begin again.

It is thus on the one hand ensured that the components are always discharged in the correct mixture ratio. In addition, the overall process is accelerated in the case of only partially filled cartridges.

The load state of the drives is advantageously determined by means of the current consumption of the drives.

In another advantageous embodiment, the determination of the load state takes place using mechanical means. For this purpose, the piston is connected by means of a spring to a drive rod. Said spring is compressed at the moment when the piston reaches the material. The compression of the spring can then advantageously be detected outside the cartridges of one advantageous embodiment in that the piston rod projects outward through the drive rod, so that it is possible outside the cartridge to detect that the piston rod is no longer moving or is moving only to a small extent even though the drive rod is still being driven. Said relative movement can for example be detected by means of a microswitch or by means of a light barrier.

Said embodiment has the following further advantage. The discharge of the material does not take place at the start with the full force and speed, since the spring initially deflects. Said “soft start” has the advantage that the discharge does not begin abruptly and immediately with full force, which could lead to a non-uniform mixture at least at the start.

Said “soft start” can, in another advantageous embodiment, be obtained in that, during the detection of the load state, the piston is initially retracted a short distance before it begins the feed movement.

If, when the emptying position of a piston in at least one cartridge is reached, the drives are reversed and operated with the higher speed, then when at least one of the cartridges has been emptied, the pistons are quickly retracted into the position in which the cartridges can then be exchanged. This also increases the speed with which work can be carried out.

The feed speed has different optimum values depending on the material. The feed speed should therefore be set correspondingly. In one advantageous embodiment, this takes place automatically by virtue of the adjustment of the feed speed to constant values taking place as a function of the pressing-out behavior of the components, which is compared with stored or calculated values for known materials. Said measure (EP 1 297 379 A1) prevents operating errors and simplifies operation. The pressing-out behavior can be detected here in different ways, for example by means of the current required for the drive, by means of deformation of the cartridge etc.

A device for carrying out the method is characterized in that said device has:
cartridges for in each case one component for a multicomponent compound, in particular for dental purposes, which cartridges are provided with in each case one piston and a drive for pressing out the component,
devices for determining the load states of the drives and for adjusting the feed speeds, and
a mixer for the components pressed out of the cartridges.

If a device for producing a multicomponent compound having a dynamic mixer is used, then it can be provided that the drive for the mixer is first switched on when the load state is detected for one or more pistons.

### BRIEF DESCRIPTION OF THE DRAWINGS

In the drawings:

FIG. 1 schematically shows the construction of the device; and

FIG. 2 shows a partial section of another advantageous embodiment.

### DETAILED DESCRIPTION

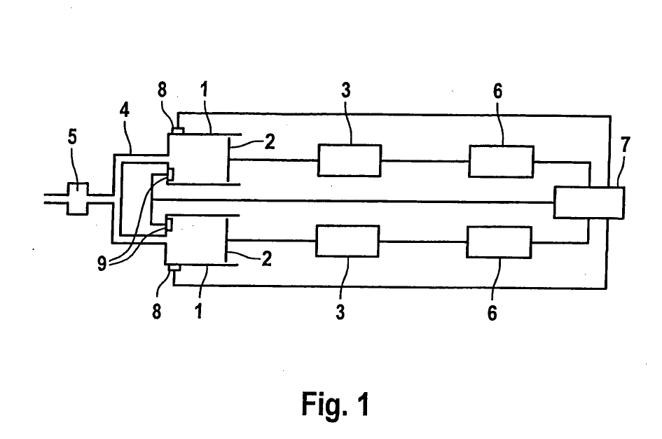

The device illustrated schematically in FIG. 1 has two cartridges or cylinders 1 in which is situated in each case one component. Arranged in said cylinders 1 are pistons 2 which are pressed into the cylinders 1 by means of drives 3 in order to feed the material via lines 4 into a mixer 5, where the components are mixed and then subsequently emerge from the mixer 5. The drives 3 are driven by means of units 6 with which the current consumption of the drives 3 is also measured. Here, the feed speeds of the pistons 2 are set by means of a controller 7 in such a way that said feed speeds assume constant values when the cylinders 1 are filled. If one or more of the cylinders 1 are only partially filled, then the feed speed of the corresponding piston 2 is increased until air pockets are eliminated and the actual pressing-out process can begin. The pressing-out behavior can be detected for example by means of pressure sensors 8 which detect the pressure or the deformation of the cylinders 1. Said signals can then be compared with values which are calculated or stored in the unit 7 in order to determine which components are situated in the cylinders 1 in order to set the optimum feed speeds for said components. The reference symbol 9 indicates yet further devices with which the emptying positions of the pistons can be detected in order that the pistons 2 can be moved back with increased speed in order that the cartridges 1 can be exchanged. By means of corresponding control with the unit 7, it is also possible to carry out a so-called “soft start”. If the increased load state of a piston is detected (or of both pistons), said piston is first retracted slightly and only then is the pressing-out process started. The advantage is that the pressing-out process does not begin abruptly, which could result in the initial phase in a poor mixture ratio.

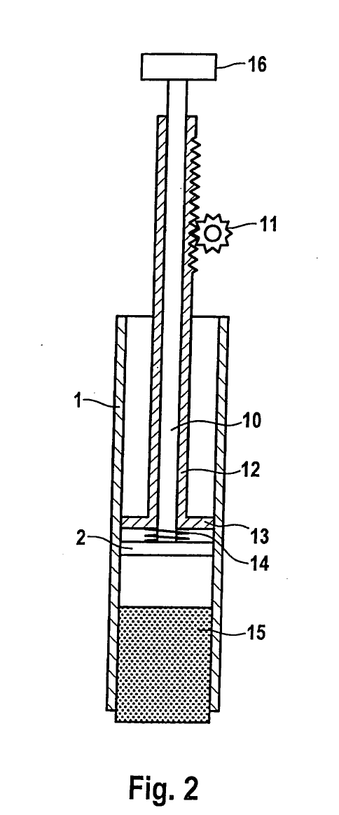

FIG. 2 schematically illustrates another embodiment, specifically only one cartridge 1 with a piston 2, although the device according to the invention of course has a plurality of such cartridges 1 and pistons 2. Here, the drive takes place not to the piston rod 10 but rather via a gearwheel 11, which is connected to a drive (not shown), on a drive rod 12 which is of toothed-rack-like design in the upper part. The piston rod 10 is arranged, and guided so as to be axially movable, in said drive rod 12. Situated between a lower extension 13 of the rod and the piston 2 is a pressure spring 14. If the drive rod 12 is moved downwards by the drive gearwheel 11 and the piston 2 reaches the material 15, then the spring 14 is compressed. The relative movement between the drive rod 12 and the piston rod 10 can then be detected by means of a measuring device 16 which is arranged outside the cartridge 1. Said measuring device 16 can be a light barrier or a microswitch. On account of the action of the spring 14, it is thus possible to detect not only the load state. A “soft start” is in fact also obtained by virtue of the full force not acting on the material 15 immediately.

1. A method for producing a multicomponent compound, by pressing its components out of cartridges by means of pistons, each of which pistons is provided with a separate drive, and by mixing the components, characterized in that, during the pressing-out operation, the load state of the drives is determined, and
if the load state is detected for all the drives, the feed speeds are adjusted to predetermined constant values,
if the load state is detected for only some of the drives, said drives are stopped while the other drives are operated with higher feed speeds until the load state is also detected in each case in said other drives, and are then stopped, and in that the feed speeds for all the drives are subsequently adjusted to predetermined constant values.
if the load state is detected for none of the drives, the drives are operated with higher feed speeds until the load state is detected in each case in said drives, and are then stopped, and in that the feed speeds for all the drives are subsequently adjusted to predetermined constant values.

2. The method as claimed in claim 1, characterized in that the load state of the drives is determined by means of the current consumption of the drives.

3. The method as claimed in claim 1, characterized in that the load state of the drives is determined using mechanical means.

4. The method as claimed in claim 1, characterized in that, during the detection of the load state, the pistons are retracted a short distance before the feed for dispensing the material is started.

5. The method as claimed in claim 1, characterized in that, when the emptying position of a piston in at least one cartridge is reached, the drives are reversed and operated with the higher speed.

6. The method as claimed in claim 1, characterized in that the adjustment of the feed speeds to constant values takes place as a function of the pressing-out behavior of the components, which is compared with stored or calculated values for known materials.

7. The method as claimed in claim 1, in which the components are mixed with a dynamic mixer after being pressed out of the cartridges, characterized in that the mixer is driven first from the moment at which one or more pistons reach the load state.

8. A device for carrying out the method as claimed in claim 1, characterized in that said device has:
cartridges for in each case one component for a multicomponent compound which cartridges are provided with in each case one piston and a drive for pressing out the component,
a mixer for the components pressed out of the cartridges, and
devices for determining the load states of the drives and for adjusting the feed speeds, which devices are designed to firstly operate all the drives with a higher feed speed for as long as no load state is detected for said drives, and to then stop the drives, and to then operate the drives with a feed speed which is adjusted to predetermined constant values.

9. The device as claimed in claim 8, characterized in that said device has devices for detecting those pistons which are in the emptying positions.

10. The device as claimed in claim 8, characterized in that the devices for determining the load states are current measuring devices.

11. The device as claimed in claim 8, characterized in that the devices for determining the load states are light barriers or microswitches for detecting the mechanical position of the pistons.

12. The device as claimed in claim 8, characterized in that the pistons are connected by means of in each case one spring to a drive rod.

13. The device as claimed in claim 8, characterized in that said device has delay circuits with which the pistons are retracted slightly when the load state is reached before the pressing-out is started.

14. The device as claimed in claim 8, characterized in that said device has apparatuses for detecting the pressing-out behavior of the components.

15. The method as claimed in claim 2, characterized in that, during the detection of the load state, the pistons are retracted a short distance before the feed for dispensing the material is started.

16. The method as claimed in claim 3, characterized in that, during the detection of the load state, the pistons are retracted a short distance before the feed for dispensing the material is started.

17. The method as claimed in claim 2, characterized in that, when the emptying position of a piston in at least one cartridge is reached, the drives are reversed and operated with the higher speed.

18. The method as claimed in claim 3, characterized in that, when the emptying position of a piston in at least one cartridge is reached, the drives are reversed and operated with the higher speed.

19. The method as claimed in claim 4, characterized in that, when the emptying position of a piston in at least one cartridge is reached, the drives are reversed and operated with the higher speed.

20. The method as claimed in claim 2, characterized in that the adjustment of the feed speeds to constant values takes place as a function of the pressing-out behavior of the components, which is compared with stored or calculated values for known materials.
